(19) United States
(12) Patent Application Publication
(10) Pub. No.: US 2020/0121112 A1
(43) Pub. Date: Apr. 23, 2020

(54) FLUID HEATING DEVICE AND HEATING COOKER

(71) Applicant: SHARP KABUSHIKI KAISHA, Sakai City (JP)

(72) Inventors: SHINYA UEDA, Sakai City (JP); MASAYUKI UNO, Sakai City (JP)

(21) Appl. No.: 16/601,878

(22) Filed: Oct. 15, 2019

(30) Foreign Application Priority Data
Oct. 17, 2018 (JP) 2018-196096

(51) Int. Cl. A47J 27/04

(52) U.S. Cl. CPC A47J 27/04; A47J 2027/043

(57) ABSTRACT

A steam supplying device includes: a heater that heats fluid; and a heating tube through which the fluid flows, the heating tube being spirally wound around the heater.

### BACKGROUND

### 1. Field

The present disclosure relates to a fluid heating device that heats fluid, such as water and steam.

### 2. Description of the Related Art

A liquid heating device disclosed in Japanese Unexamined Patent Application Publication No. 2015-26565 (published on Feb. 5, 2015) is an example of a liquid heating device that heats liquid, which is a fluid.

The liquid heating device includes: a spiral heater that heats liquid; a spiral heating tube including tiers each arranged between two corresponding adjacent tiers of a spiral of the heater; and a material portion made of a heat-transfer material for filling a gap between the heater and the heating tube.

Owing to this configuration, a liquid heating device that yields improvements over conventional liquid heating devices in terms of size reduction, high thermal efficiency, and low production cost is realized.

The liquid heating device disclosed in Japanese Unexamined Patent Application Publication No. 2015-26565 (published on Feb. 5, 2015) includes aluminum (an aluminum die casting) as the heat-transfer material for filling a gap between the heater and the heating tube. With this configuration, heat generated by the heater is transferred to the heating tube through aluminum. Insufficient heating of aluminum may lead to insufficient heating of the fluid flowing through the heating tube. Such a structure that transfers heat generated by the heater to the heating tube still has room for improvement in its ability to rapidly raise the temperature of the fluid flowing through the heating tube and to adjust the temperature of the fluid flowing through the heating tube.

### SUMMARY

An embodiment of the present disclosure provides a fluid heating device capable of rapidly raising the temperature of fluid flowing through a heating tube and enabling easy adjustment of the temperature of the fluid flowing through the heating tube.

To solve the aforementioned problem, a fluid heating device for heating fluid according to an embodiment of the present disclosure includes: a heater that heats fluid; and a heating tube through which the fluid flows. The heating tube is spirally wound around the heater.

### BRIEF DESCRIPTION OF THE DRAWINGS

FIG. 1 is a perspective view of a heating unit included in a fluid heating device according to Embodiment 1 of the present disclosure, illustrating a schematic configuration thereof;

FIG. 2A is a perspective view of a heating cooker including the heating unit illustrated in FIG. 1, schematically illustrating the internal structure of the heating cooker seen from behind and obliquely above;

FIG. 2B is a rear view of the heating cooker, schematically illustrating the internal structure thereof; and

FIG. 3 is a schematic block diagram illustrating a control unit of the heating cooker illustrated in FIGS. 2A and 2B.

### DESCRIPTION OF THE EMBODIMENTS

### Embodiment 1

An embodiment of the present disclosure will be described below in detail. The embodiment below is an example of applying a fluid heating device according to the present disclosure to a steam generator of a heating cooker. Fluids to be heated in the present embodiment are water and steam.

### Steam Supplying Device

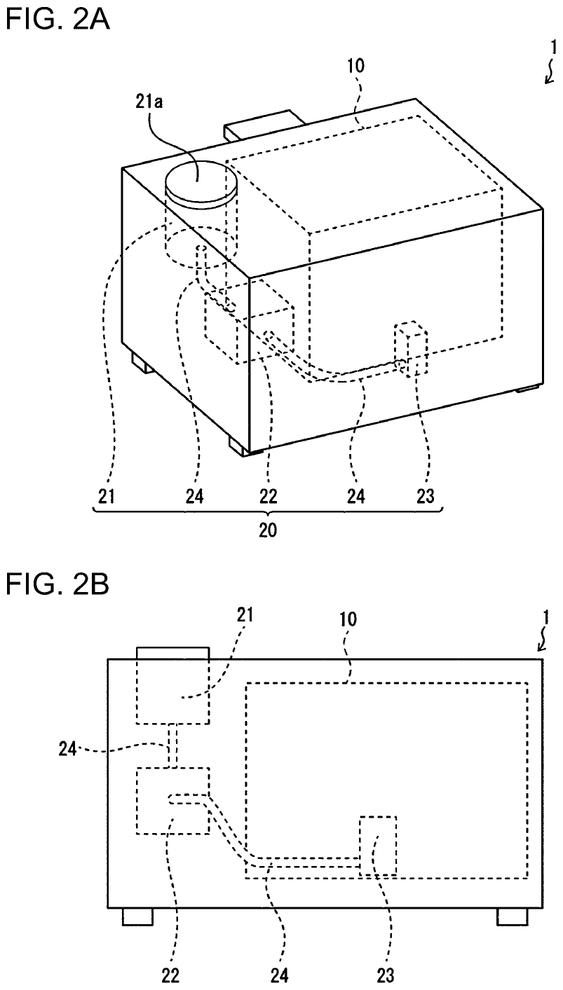

FIG. 2A is a perspective view of a heating cooker 1 according to the present embodiment, schematically illustrating the internal structure of the heating cooker 1 seen from behind and obliquely above. FIG. 2B is a rear view of the heating cooker 1, schematically illustrating the internal structure thereof.

As illustrated in FIG. 2A, the heating cooker 1 accommodates a steam supplying device 20 that supplies steam or superheated steam to a cooking chamber 10. The steam supplying device 20 includes: a water tank 21 that stores water; a pump 22 that delivers water from the water tank 21; and a steam generating unit 23 that generates steam or superheated steam by using the delivered water. A supply pipe 24, through which water flows, forms a link between the water tank 21 and the pump 22 and a link between the pump 22 and the steam generating unit 23.

A tank lid 21a is disposed on the upper side of the water tank 21. A user can pull out the water tank 21 from a water-tank receiving portion and remove the tank lid 21a to pour water into the water tank 21. The pump 22 is driven to deliver the water stored in the water tank 21 to the steam generating unit 23 through the supply pipe 24.

### Control of Steam Supplying Device

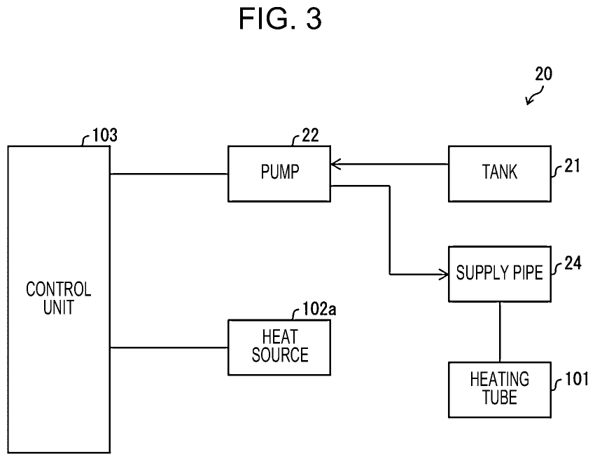

The steam supplying device 20 includes a control unit 103 as illustrated in FIG. 3 to control the pump 22 and to control a heat source 102a.

The control unit 103 controls the pump 22 to send the fluid (water) from the water tank 21 to the supply pipe 24. A heating tube 101, which is one of the constituent components of the steam generating unit 23, is connected to a tip of the supply pipe 24. Thus, the fluid (water) sent through the supply pipe 24 is then supplied to the heating tube 101.

The control unit 103 controls the heat source 102a to control heating caused by a heater 102, which will be described later.

Heating Unit

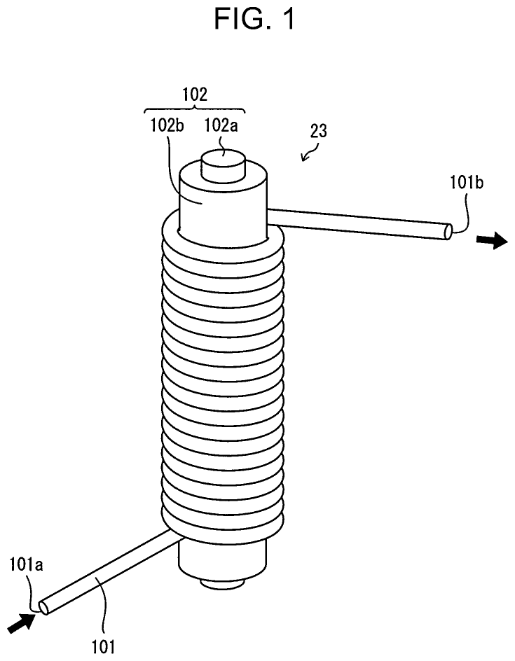

FIG. 1 is a perspective view of the steam generating unit 23 included, as a heating unit, in the steam supplying device 20 of the heating cooker 1, illustrating a schematic configuration of the steam generating unit 23. As illustrated in FIG. 1, the steam generating unit 23 includes the heating tube 101, through which fluid flows, and the heater 102 that heats the fluid flowing through the heating tube 101.

The heating tube 101 is spirally folded in a manner so as to be wound around the heater 102. The liquid to be heated is supplied from the supply pipe 24 of the steam supplying device 20 to a feedwater orifice 101a, flows through the heating tube 101 along a spiral channel, and is discharged from a steam-jet orifice 101b.

The heating tube 101 is preferably formed from a material having high thermal conductivity and high bendability, such as a copper alloy or an aluminum alloy. In light of corrosion resistance, stainless steel is preferred. In the present embodiment, a stainless-steel pipe is used as the heating tube 101.

Winding the heating tube 101 around the heater 102 increases the proportion of the surface area that receives heat directly from the heater 102. Heat generated by the heater 102 is thus transferred substantially in its entirety throughout the heating tube 101. By adjusting the temperature of the heater 102, the amount of heat transferred to the heating tube 101 is regulated accordingly. Thus, the temperature of the fluid flowing through the heating tube 101 may be easily raised and/or adjusted.

The heater 102 is a glass tube heater and includes a glass tube 102b and the heat source 102a embedded in the glass tube 102b. The heating tube 101 is wound around the circumferential surface of the glass tube 102b. Metal of high electrical resistance, such as a nichrome wire, is used as the heat source 102a. The heat source 102a is driven and controlled by the control unit 103 mentioned above.

When a larger amount of current flows through the heat source 102a, the temperature of the heat source 102a is raised to a high temperature (e.g., about 800° C.) accordingly, and the surface of the glass tube 102b is also heated to a high temperature. This means that the surface of the glass tube 102b may be rapidly heated to a high temperature (e.g., about 800° C.). As a result, the fluid flowing through the heating tube 101 may also be heated to about 500° C.

When the fluid to be used is water, the steam generating unit 23 is capable of generating superheated steam at about 500° C. Thus, superheated steam at about 500° C. can be supplied to the cooking chamber (heating chamber) 10 of the heating cooker 1.

When the steam generating unit 23 is configured to discharge heated liquid such as hot water, the diameter of the steam-jet orifice 101b of the heating tube 101 does not need to be changed in accordance with the diameter of the heating tube 101. When the steam generating unit 23 is configured to discharge vapor of liquid (such as water vapor) generated by heating liquid or vapor flowing through the heating tube 101, the diameter of the steam-jet orifice 101b of the heating tube 101 is preferably smaller than the diameter of the heating tube 101 so that the desired velocity of vapor jets is attained.

The heating tube 101 is wound around the heater 102 with no space between adjacent winding turns of the heating tube 101. That is, the heating tube 101 is wound around the heater 102 with no space between adjacent tiers of the spiral formed by the heating tube 101. The term “tier” herein refers to each of the winding turns constituting the spiral. Winding the heating tube 101 around the heater 102 with no space between adjacent winding turns of the heating tube 101 will minimize leakage of heat from the heating tube 101 and enable more efficient heating of the fluid flowing through the heating tube 101.

Embodiments 2 and 3, which will be described below, are examples for enabling still more efficient heating of the fluid flowing through the heating tube 101.

### Embodiment 2

The following describes another embodiment of the present disclosure. For convenience, the same reference signs refer to members having the same functions as the members described in the embodiment above, and redundant description thereof will be omitted.

### Heating Tube

The steam generating unit 23 may be configured in such a manner that the heating tube 101 is wound around the heater 102 to be in close contact with the circumferential surface of the heater 102. This configuration enables heat generated by the heater 102 to be transferred directly to the heating tube 101 and thus enables more efficient heating of the fluid flowing through the heating tube 101.

Additionally, winding the heating tube 101 around the heater 102 with no space between adjacent winding turns of the heating tube 101 as in Embodiment 1 above enables still more efficient heating of the fluid flowing through the heating tube 101.

### Embodiment 3

The following describes still another embodiment of the present disclosure. For convenience, the same reference signs refer to members having the same functions as the members described in the embodiments above, and redundant description thereof will be omitted.

### Heating Tube

The steam generating unit 23 may be configured in such a manner that the heating tube 101 has a black coating applied to its winding surface placed around the heater 102. That is, a black coating may be applied to a surface portion of the heating tube 101 wound around the heater 102 and facing the heater 102. The heating tube 101 can absorb a greater amount of heat from the heater 102 through the surface portion to which the black coating is applied. This configuration thus enables more efficient heating of the fluid flowing through the heating tube 101.

Additionally, winding the heating tube 101 around the heater 102 with no space between adjacent winding turns of the heating tube 101 as in Embodiment 1 above enables still more efficient heating of the fluid flowing through the heating tube 101. Furthermore, winding the heating tube 101 around the heater 102 to bring the heating tube 101 into close contact with the circumferential surface of the heater 102 as in Embodiment 2 above also enables still more efficient heating of the fluid flowing through the heating tube 101.

### Modifications

Embodiments 1 to 3 above describe that the heater to be included is a glass tube heater. The heat source (heating element) of the glass tube heater may be formed from a nichrome-based or carbon-based material. To provide an inexpensive fluid heating device, a nichrome-based material is preferably used instead of a carbon-based material, which is expensive.

In the present disclosure, heaters of any type or of any structure that are capable of heating the fluid flowing through the heating tube 101 to about 500° C. may be used. The temperature to which the fluid is to be heated is not limited to 500° C. and may be higher than 500° C. or lower than 500° C. The fluid is not limited to water. In some embodiments, fluids other than water may be used.

The present disclosure is not limited to the embodiments described above, and various alterations may be made within the scope of the appended claims. Embodiments obtained by combining the techniques of different embodiments as appropriate also fall within the technical scope of the present disclosure. Furthermore, combinations of the techniques of the embodiments may produce new technical features.

The present disclosure contains subject matter related to that disclosed in Japanese Priority Patent Application JP 2018-196096 filed in the Japan Patent Office on Oct. 17, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fluid heating device for heating fluid, comprising:
a heater that heats fluid; and
a heating tube through which the fluid flows, the heating tube being spirally wound around the heater.

2. The fluid heating device according to claim 1, wherein the heater is a glass tube heater including a heat source embedded therein.

3. The fluid heating device according to claim 1, wherein the heating tube is wound around the heater with no space between adjacent winding turns of the heating tube.

4. The fluid heating device according to claim 1, wherein the heating tube is wound around the heater to be in close contact with a circumferential surface of the heater.

5. The fluid heating device according to claim 1, wherein the heating tube has a black coating applied to a winding surface thereof, the winding surface being placed around the heater.

6. A heating cooker, comprising a steam supplying device that includes the fluid heating device according to claim 1 to supply at least one of steam and superheated steam to a heating chamber.
